(19) United States
(12) Patent Application Publication
(10) Pub. No.: US 2004/0104269 A1
(43) Pub. Date: Jun. 3, 2004

(54) System and method for distributing machine-readable media for promoting electronic commerce

(76) Inventor: Brady Bisson, Basking Ridge, NJ (US)

Correspondence Address: Ronald Abramson, Hughes Hubbard & Reed LLP, One Battery Park Plaza, New York, NY, 10004-1482, US

(21) Appl. No.: 10/671,173

(22) Filed: Sep. 24, 2003

Related U.S. Application Data
(60) Provisional application No. 60/413,100, filed on Sep. 24, 2002.

(51) Int. Cl. G06K 7/08

(52) U.S. Cl. 235/449

(57) ABSTRACT

A “swipe”-type magnetic stripe reader suitable as a low-cost computer peripheral is described, together with distribution programs to create incentives for the wide deployment of the readers. The readers are used in conjunction with methods for distributing, through print media, machine readable, magnetically encoded media that may be read with the readers. An optional authentication mechanism may be built into the readers that can be used to control their use, based on information encoded into the machine-readable media that have been distributed. The encoded authentication information can, for example, be keyed to whether an advertiser has been authorized, and/or based on temporal criteria, so as to provide for effective time periods for a promotion.

### CROSS REFERENCE TO RELATED APPLICATION

This application claims benefit of U.S. provisional application Serial No. 60/413,100, filed on Sep. 24, 2002.

### BACKGROUND OF THE INVENTION

1. Field of the Invention

The present invention relates to the field of electronic commerce, and more particularly to enhanced methods of promoting electronic commerce by distributing machine-readable media in conjunction with traditional print media.

2. Description of Related Art

Advertising is widely employed to publicize and promote electronic commerce web sites on the Internet, and thereby stimulate sales activity through such sites. Such advertising typically takes the form of advertising on other web sites, search engine placements, as well as advertising in traditional media, including radio and television, and further including print media such as newspapers, magazines and direct mail.

When businesses having e-commerce sites advertise in print media, it is common practice to promote their e-commerce sites by including a Uniform Resource Locator (URL) in the printed advertisement (e.g., a magazine ad, or a mailed circular). Such addresses can also be displayed or announced in a TV or radio advertisement. By using the advertiser-supplied URL or domain name, consumers reading the print ad (or watching or listening to a TV or radio advertisement) can follow up and visit the designated site, and thereby obtain further information, participate in promotions or contests, or make purchases.

The prior art methods of combining electronic and traditional ads, however, have several drawbacks. The consumer has to manually enter the URL in a web browser program, on a computer that has an Internet connection. The URL, especially one for a specific product or offer, may be long and complex, containing symbols that may be unfamiliar to many users. A slight mistake in manually entering the URL, such as mistaking a backslash for a forward slash, or a dash for an underscore, can prevent the consumer from accessing the particular web site, or cause the consumer to access an unrelated web site or web page. Moreover, it is unlikely that a long, complicated URL will be entered at all, or entered correctly, by many consumers. Thus, for a number of reasons, it is more practical when advertising in such media to limit the URL to the domain name of the advertiser. One expedient is to establish domain name dedicated to the advertised offer, calculated to be easily remembered and associated, but it is often difficult to obtain a suitable domain name, especially if it is short.

In the absence of a custom domain name, a product- or offer-specific URL will in general be long and contain non-alphabetic symbols. Some consumers might not be able to find these symbols on, or generate them with, their keyboard, while others may not possess requisite the patience or motivation. The group of consumers who will actually log on to a web site after viewing the corresponding printed ad will often represent only a small fraction of the total population that read the ad, and the majority of those consumers who do visit the site in response to the ad will likely just go to the home page of the site and may not find the product or offer that was the subject of the advertisement. Thus, the current methods of using print media to promote commerce in electronic media are inefficient, and the inefficiency is compounded by the fact that well-placed print advertising is expensive.

Others have attempted to address these drawbacks, but with limited success.

U.S. Pat. No. 5,971,277 to Cragun et al. teaches an Internet-based information retrieval system comprising a client computer with a scanner capable of scanning encoded objects for a URL which specifies both a server computer and a location within the server where relevant information is stored.

U.S. Pat. No. 5,978,773 to Hudetz et al. teaches a system and method comprising a database that relates Uniform Product Code (UPC) numbers to URLs. To access a particular Internet resource associated with an URL, the user may scan the UPC symbol printed on the label of a product.

U.S. Patent Application Publication No. 2002/0083123 A1 by Freedman et al. teaches a web-based method for directing a consumer to the advertisers web site by allowing the consumer to utilize a scanner peripheral to scan an encoded URL in a printed indicia.

However, the prior art does not teach either (a) an extremely low cost device for reading the distributed media, which may feasibly achieve wide market penetration without prohibitive production and distribution expense, or (b) a dynamic, that is controllable, method of relating print media to electronic media. As for the former (a), cost of deployment can prove fatal to a marketing effort that depends on wide circulation of a computer peripheral. As for the latter (b), an organization that has made a considerable investment in deploying hardware to read distributed machine-readable media would not want anyone able to produce the inexpensive media to be able to “free ride” on the system.

Several prior art references, such as those noted above, teach hand-held optical scanners or magnetic card readers, but have not fully solved the problem of reducing the manufacturing cost of such devices to the point desirable for the type of promotion contemplated by the present invention. Some of the prior art references teach user authorization that allows the identity of the user to be ascertained by checking a centralized database. However, none of the references teach content authorization. Content authorization is an optional feature that can be used to limit the use of the system to advertisers whose advertisements have been authorized. Another context where content authorization could be used is in the case of time sensitive content. For example, it may be desired that a web site promoting a movie be made accessible only during the theatrical run of the movie. Another example would be a web site promoting a certain limited-time discount offer. In a system that relates printed media to electronic media, it would be desirable to have a content authorization component so that, in the previous examples, attempts to access the electronic media after the authorized time period would not be successful. Preferably, this content authorization check would not be done over the network, so that unnecessary web traffic, server infrastructure and security risk could be avoided.

### SUMMARY OF THE INVENTION

Accordingly, it is an object of the invention to provide an efficient and cost-effective way to distribute, via traditional print media, machine-readable media containing information that will direct a consumer to a specified URL.

It is a further object of the invention to provide a cost-effective reader for such machine-readable media that can easily be distributed to consumers and used by them in order to read such machine readable media.

It is a further object of the invention to provide an economic and practical method of distributing such readers and related methods for incentivizing their wide distribution and deployment.

It is a further object of the invention to provide effective methods to motivate consumers to obtain and deploy such readers, and to use them to read the distributed machine readable media.

It is a further object of the invention to provide effective means to limit the use of said reader to the processing of URLs for which authorization has been provided.

In one embodiment, these and other objects of the invention are accomplished through the distribution of a “swipe”-type magnetic stripe reader suitable as a low-cost computer peripheral. Distribution programs are provided to create incentives for the wide deployment of the readers. The readers are then used in conjunction with methods for distributing, through print media, machine readable, magnetically encoded media that may be read with the readers. An optional authentication mechanism may be built into the readers that can be used to control their use, based on information encoded into the machine-readable media that have been distributed. The encoded authentication information can, for example, be keyed to whether an advertiser has been authorized, and/or based on temporal criteria, so as to provide for effective time periods for a promotion.

The manner in which the invention achieves these and other objectives and overcomes the shortcomings of the prior art is more fully explained in the detailed description that follows, and illustrated in the accompanying drawings.

### BRIEF DESCRIPTION OF THE DRAWINGS

FIG. 1 is a flowchart depicting the distribution program according to the present invention.

FIGS. 2A and 2B show two embodiments of a card reader according to the present invention.

FIG. 3 is a flowchart depicting an operation of accessing electronic media according to the present invention.

FIG. 4 is a flowchart depicting an operation of obtaining subscribers according to the present invention.

FIG. 5 is a block diagram of information contained in the distribution program according to the present invention.

FIG. 6 is a flowchart depicting an operation of producing cards according to the present invention.

FIG. 7 is a flowchart depicting an operation of distributing cards according to the present invention.

### DETAILED DESCRIPTION

The following is a description of several preferred embodiments of various aspects of the invention, showing details of how apparatus and systems may be constructed to carry out the invention, and of steps that might be employed to utilize such apparatus and systems to practice the methods of the invention. These embodiments are illustrative only, and the invention is by no means limited to these particular examples. Other embodiments of the system according to the invention could be devised by a person of ordinary skill in the art without going beyond the scope of the invention. The specific features of any particular embodiment should not be understood as limiting the scope of what may be claimed.

In one embodiment, the invention concerns, in part, distribution of a low-cost reader that may be used by the consumer as a computer peripheral, for example, plugged into the keyboard port or a serial port. The reader may be user to read magnetically encoded media by “swiping” the media through the reader.

Other aspects of the invention involve the technical details of how the readers read the distributed machine-readable media and present the desired information to the consumer; the types of authentication provided, and how such authentication is implemented; and business methods, such as how the distribution of readers and advertisements may be funded, the programs whereby readers are distributed, so as to achieve wide deployment, the process whereby advertisers are obtained and advertisements created for use in this system, the manner in which consumers are induced to use the readers after they have obtained them, and the process whereby advertisements are distributed in conjunction with print media.

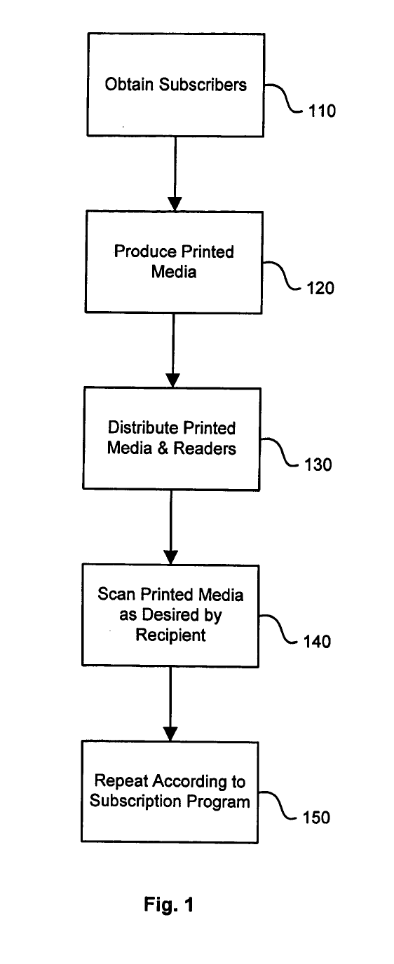

An overview of the manner of practicing an embodiment of the invention is provided in FIG. 1. The steps outlined therein, which are summary in nature and will be further elaborated upon herein, comprise the following:

An advertiser (subscriber), contracts to use magnetic strip cards for print advertisement (110). These businesses or other parties use the distribution program according to the present invention to achieve the goal of using both print and electronic media so that exposures of their advertisements are maximized. Subscribers may be businesses seeking to advertise their products or services, but it should be understood that subscribers could be other persons or organizations seeking to use the invention for other purposes, for example, to promote or enable participation in governmental, charitable or educational activities or processes.

Printed media containing advertising or other artwork printed on a card is produced (120), including encoded strips with information which may comprise a response URL on the World Wide Web. Printed media from all the advertisers parties may be bundled together and sent as a package, or the printed media may be sent individually.

magnetic strip readers are distributed to consumers under a suitable distribution program (130), which may involve sending the reader with the printed media, or providing it separately.

consumer scans printed media as desired (140), which may be (for example) by swiping a magnetic strip through a reader, or wanding it.

information is captured and target URL is passed from the reader to the user's Web browser, which is directed to a web site specified by the information contained in the card, where any further information can be provided and/or transaction(s) initiated.

the foregoing process is repeated (150) in accordance with the applicable distribution program

In other embodiments, additional steps may be employed, such as:

the advertiser is given an authorization code in conjunction with contract;

the encoded strip includes this authorization code; and

when the strip is “swiped” by the consumer, the authorization code is also read and checked against a database to control whether URL is opened in the browser.

The details of certain embodiments of the above-described methods, and exemplary apparatus and systems that may be used in connection therewith are described below.

(1) The Magnetic Stripe Reader

It is desirable to provide a peripheral suitable for distribution to consumers so as to enable them to read machine-readable media that may be distributed or made available to them from time to time. In one of the embodiments contemplated, where such readers are provided at no cost to recipients, large numbers of readers would have to be supplied, where the entire cost of reader production would have be placed on the administrators of the distribution program or its subscribers. Therefore it is advantageous to develop a reader for the present invention that would be inexpensive to produce. Design objectives for such a reader include low parts count, low complexity, inexpensive materials and components, an electrical interface conforming to an already widely available standard, physical ruggedness so as to withstand shipment and subsequent consumer use, handling and storage, and a compact size suitable for inexpensive shipment.

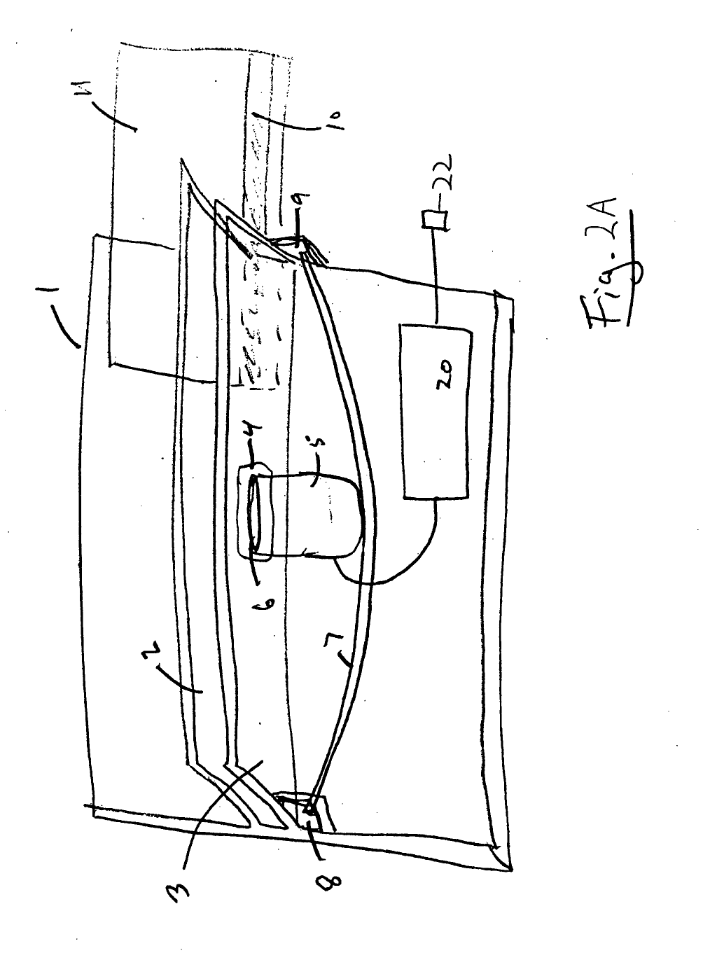

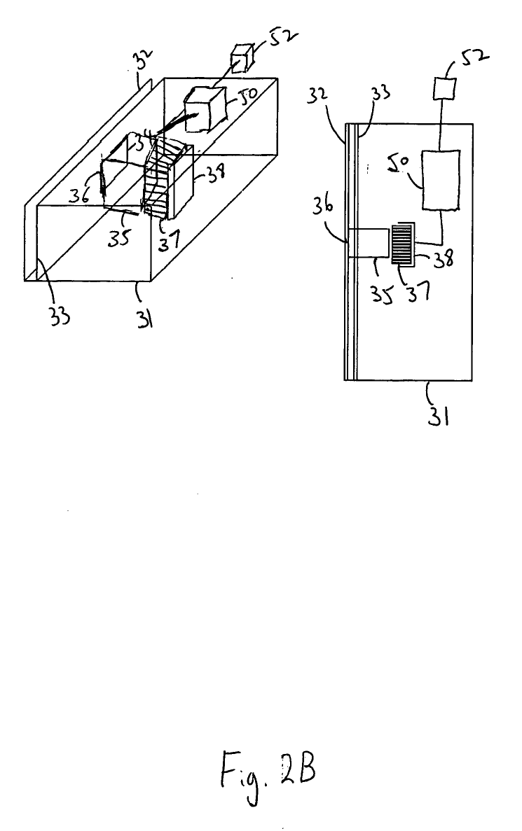

Referring to FIGS. 2A and 2B, certain embodiments of magnetic stripe reader that may be used in connection with the present invention comprise the following:

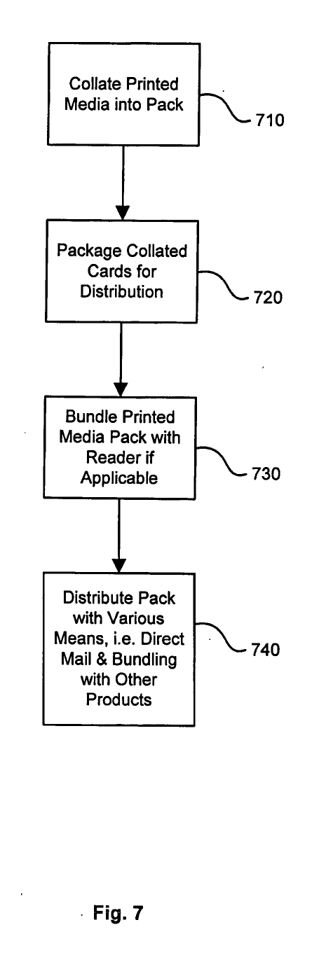

(A) a holder (1) having a guide fence (2) for a magnetic strip, an opposing wall (3), which together with guide fence (2) forms a channel for a magnetic strip (10) on substrate (11), an opening (4) in said opposing wall, a magnetic head assembly (5) disposed in opening (4) so that magnetic head (6) faces toward, is guided, and may be moved so as to press against guide fence (2), and compression means (7), such as spring member (7A) in FIG. 2A or elastic material (7B) in FIG. 7B, held under compression at its ends by detention surfaces (8, 9) of holder (1) in FIG. 2A, or by partial enclosure (8B) in FIG. 2B, so as to and cause compression means (7) to exert pressure against magnetic head assembly (5) so as to bias magnetic head assembly (5) against guide fence (2) and maintain positive contact with said magnetic strip (10) as it is swiped through said channel; and

(B) electronic components (20) to interface said magnetic head assembly (5) with a personal computer.

While FIG. 2A shows the base of holder 1 extending beyond guide fence 2 (in the direction opposite head assembly 5), said base may, in either embodiment depicted, end at or near the guide fence (as shown in FIG. 2B).

This design has a low parts count, has a shell constructed out of plastic that may be injection molded, uses head and electronic components currently available as commodity items or that may be inexpensively manufactured in quantity on a custom basis. Read heads may be of the traditional units consisting of a core with windings or based on thin film technology. Readers may be capable of reading one, two, three, or more encoded tracks. The electronic circuit employed can be purchased and/or specified to have a commonly available interface such as a serial port or PS/2 keyboard interface. The design is well suited to a rugged package, yet compact and lightweight, readily lending itself to distribution by mail.

(2) Operation of the Reader, including the Authentication Function

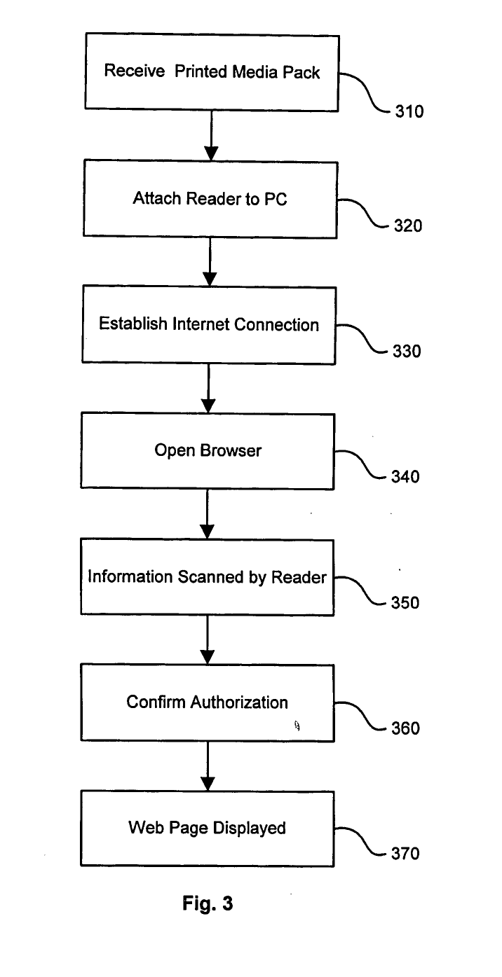

FIG. 3 shows the operation of step 140 in FIG. 1 in further detail.

In one embodiment, a recipient who has a reader receives printed media having a magnetically encoded stripe on an edge in accordance with encoding techniques well known in the art (310).

If not previously attached, the recipient will attach the reader to a PC or laptop computer or other suitable terminal equipment (320). The attachment may include communication channels with the computer and means for the computer to provide power to the reader.

Once the reader is attached, the recipient will initiate a connection to the Internet (330), unless the connection is already active, and open a web browser (340). In an alternative embodiment, the reader may communicate with the computer to establish an Internet connection and open a web browser program.

With the Internet connection active and the web browser set as the active program, the recipient can chose one of the magnetic strip cards (if that is the media that has been provided) and swipe it through the reader (350). Otherwise, a suitable scanner, wand or other sensor may be used. The URL or the IP address of a web page may be stored in a database on connected PC or laptop for future access.

In one embodiment, a swipe of the magnetic strip card may interact with a background program to initiate a browser program and access the specified web page.

In some distribution programs, it may be desirable to include an authorization code on the magnetic strip, which is verified by the reader before transferring information from the magnetic strip to the host computer system. An authorization code based on content may be used. This will allow only those magnetic strip cards produced in conjunction with an authorized distribution program to be used with the reader. The authorization code can also be provided in association with cards having a value associated with the access, or time limit, or expiration date.

Once the swipe is accomplished, the browser will access the web page indicated by the address encoded on the magnetic strip (370). In instances where the distribution program uses an authorization code, the reader will internally check the authorization code (360) prior to transmitting information to the host system. Once a page is displayed, the user may select additional web pages from provided links or buttons.

An authorization code may be used to verify that use of the reader is authorized as part of a distribution program. Another example of authorization code use is in the case where the printed media and the associated web page is promoting a time sensitive event such as a limited time discount offer, then authorization information and the time of the deadline may be encoded in the printed media. When the recipient scans the printed media, then the reader will scan the authorization information and compare the time of the deadline information stored in the magnetic stripe with the current time. If the current time is after the time of the deadline, then the authorization information may instruct the reader to refuse access to the web page associated with the read URL, or the authorization information may instruct the reader to direct the web browser to an alternate web page. If the authorization is allowed or if there is no authorization, then the web page associated with the read URL is displayed by the browser at step 370.

A facility may be provided to disable the authorization code. Methods to disable the authorization may include instructions for the recipient, a specially encoded magnetic strip card or other means. A web page may nevertheless be displayed by the browser when authorization is refused if such mechanism is provided.

Examining the scanning and authentication steps in further detail, it is seen, referring again to FIGS. 2A and 2B, that the card reader 1 has a groove constructed by vertical members 2 and 3. Vertical members 2 and 3 are separated by a sufficient width so that a magnetic stripe card 11 having a magnetic stripe 10 can pass through the groove. One of the vertical members, in this illustration vertical member 3, has a opening 4. A head 5 having an outer head surface 6 is inserted into the opening 4. During the operation of the reader, the recipient swipes the card 11 through the groove, that is to say the card 11 is moved through the groove so that the entire magnetic stripe 10 makes passing contact with the head surface 6. A spring member 7A attached to the reader 1 at anchors 8 and 9 holds head 5 in place. By using the spring member 7A to hold head 5, a force is exerted onto head 5 so that good contact is made between the head surface 6 and the magnetic stripe 10. The outer head surface 6 has a curvature to better allow the card 11 to move through the groove when a spring force is exerted onto the head 5. For illustrative purposes, a spring member 7A is shown. However, elastic material 7B, or a coiled spring, or any other mechanism that can exert the appropriate amount force onto the head 5, can be used.

During the time the magnetic stripe 10 is in contact with the outer head surface 6, the pattern recorded on the magnetic stripe creates moving magnetic field in the vicinity of head 5. This magnetic field in turn generates an analog electrical signal within head 5 that is transmitted to electronic circuit 20. Electronic circuit 20 may have conversion means that can convert the analog signal to a digital signal. Electronic circuit 20 may also have other switching, logic, memory, clock, and/or programmable processing components for processing the data obtained from the magnetic stripe 10. Active components within electronic circuit 20 may be powered by electricity drawn from connector 22 (further described below). For example, in the case of content authentication for time sensitivity described previously, electronic circuit 20 may have an authentication component that can read the time stored on the magnetic stripe 10 and compare it against the current time to determine if the recipient is attempting to access a web site after a deadline. In case of authentication by advertiser, the authentication component can read an authorization code stored on magnetic stripe 10 and compare it against a table of valid codes, stored within electronic circuit 20, to determine whether to establish authentication. If authentication is established, then output is enabled, and the data from the magnetic stripe 10, such as URL or IP address information, is transmitted to the connected computer through a connector 22. If authentication is not established, then output of such URL or IP address information is inhibited.

The connector 22 may be a PS/2 connector, a USB connector, or any connector that the computer can accommodate. The connector may include wireless connections such as infra red or radio signal to transmit the signal to the computer. The computer, after receiving the information from the magnetic stripe 10, can then display the associated web page using a browser program. In one embodiment, this is done by decoding the magnetic flux on the magnetic strip, which represent predetermined keyboard strokes/codes, and entering the corresponding keystrokes/codes into the browser, so as to simulate manual address entry into the web browser. In another embodiment, this is done with a driver that constructs an address string from the information provided by the reader (or uses a pre-formed address string if provided by the reader), and places said string in the keyboard buffer, so as to simulate manual address entry into the web browser. Other means of interprocess communication known in the art may alternately be used in order to direct the consumer's browser to the proper destination.

Other components may be added onto other embodiments of the present invention. In an alternate embodiment, a software program may be installed onto either the computer or the electronic circuitry 20 of the reader 1. The program may be used to store information from one or more printed media in a database, or it may be used to open a browser program or applet once printed media is read by the reader 1. In such an embodiment with a software program, the magnetic stripe on the printed media may contain instructions for the program. In another alternate embodiment, the electronic circuitry 20 of the reader 1 may be designed so that it can accept credit card information. The recipient, in this embodiment, can first use the information stored in the magnetic stripe in the printed media to visit a web page and then make a purchase offered by that web page by swiping his or her credit card through the reader 1.

(3) Alternative Methods for Distributing and Deploying Readers

There is further provided in some embodiments methods for distributing readers so as to achieve a high rate of consumer deployment and use. One form of the distribution program disclosed herein involves of providing recipients with a package containing a number of credit card size magnetic strip cards. Magnetic strip card readers will be distributed to the recipient either with the cards or separately. To facilitate use of the cards, one form of distribution program involves providing the magnetic strip reader at no cost to the recipient while another form offers the reader for a cost. The cost of the reader may be included in the subscription paid by the subscriber or otherwise subsidized. By providing a magnetic strip reader, the recipient is enabled to use the cards included in the package by swiping them through the reader.

The list of recipients (consumers) may be recorded on a mailing list. Where desired, distribution of the magnetic strip readers will be tracked such that distribution of multiple readers to the same recipient can be avoided. Once the use of magnetic strip cards reaches a certain level of popularity, it is expected that a market will develop to support the sale of magnetic strip card readers through reseller and other channels.

A form of distribution program consisting of a card pack and reader at a cost to the recipient may include an incentive for the recipient to purchase the package, such as a discount on purchases (for example, by coupon) from the program subscribers, access to information of value to the recipient or where access to a web page involves a fee.

In another form, the distribution program may involve bundling of the card packs with the sale or distribution of other products, such as magazines, PCs, consumer electronics, home appliances, or anywhere else in-packed promotional materials may be used.

In order to provide subscribers (advertisers) with a cost effective means to combine print advertising and the distribution of magnetic strip cards and readers, for recipients to access corresponding Internet web pages, it is desirable to provide methods which include:

The program is funded by multiple subscribers and distributed to a large group of recipients with multiple distributions occurring over an arranged period of time.

The program is funded by a single subscriber and distributed to a specific set of recipients.

Distribution is through wholesale or retail channels for purchase buy recipients/consumers.

Subscriber cards within the program can be the same card for each distribution, or different cards, as established by the subscriber.

Print advertising or other information is printed or otherwise affixed on a magnetic strip card.

The magnetic strip card is encoded with an Internet web page address (URL or IP address).

Magnetic strip cards associated with multiple subscribers are collated and packaged for distribution to recipients.

Magnetic strip card readers are either packaged with the cards/card pack or distributed separately.

Distribution is accomplished via direct mail, handouts, inclusion with print media, inclusion with other products, or other means.

Once magnetic strip readers become widely distributed, low volume distribution programs will be offered.

(4) Methods of Obtaining Advertisers for the System

The distribution programs involve offering businesses, and other interested parties, subscriptions to distribution programs in which cards, or other printed media, with magnetic strips are encoded with a web page address (URL or IP address) specified by the subscriber and distributed to recipients via a number of means, including direct mail. The cards can be packaged as a “card pack” or distributed separately.

The distribution programs described herein provide the mechanism for which economies of scale to be achieved in which the cards and magnetic strip readers are affordable to produce and distribute. For example, a program involving 100 subscribers with a distribution to a million recipients on a monthly basis for one year, results in the production of 1.2 billion cards.

These programs result in a novel method to combine print advertising with a convenient method for accessing corresponding web pages. Since web pages can be updated frequently, subscribers have the opportunity to provide the latest information, as well as more information than could be included in standard print media advertising.

Content of the web page associated with the URL (or IP address) is to be provided by the subscriber, or developed for the subscriber, and may include promotional information, information related to products and/or services (e.g. product operation or installation information), or other material. The page may directly or through other web pages provide the user with the opportunity to purchase products and/or services. Purchase of products may include use of the provided reader to swipe a credit card.

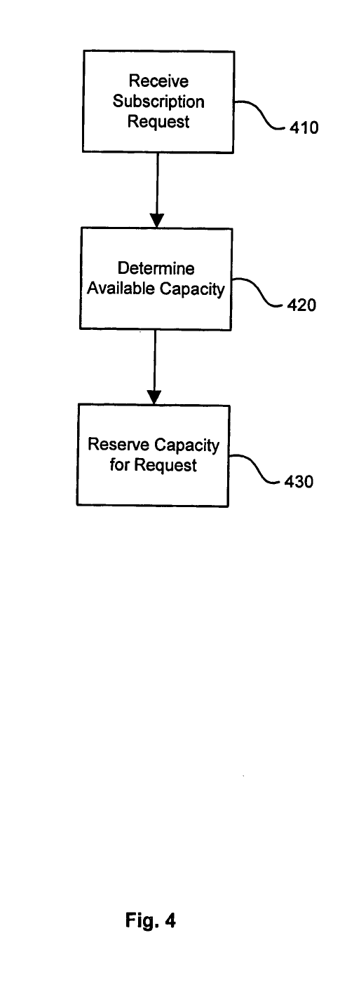

In some methods of distribution space must be reserved in advance. Referring to FIG. 4, when a subscription (advertising) request is received (410), the available capacity for the distribution date requested is determined (420). If capacity is available, it is reserved (430). Alternately, the prospective subscriber can be informed of when capacity is available.

In an example, a distribution program may have the capacity of distributing 100 magnetic stripe cards every month to a recipient. In a year, the distribution program has the capacity of producing and distributing 1,200 cards per recipient. A subscriber may contract for 1 card to be distributed in 3 of the monthly distribution events. For such a subscription, a capacity of 3 of the 1200 cards is reserved.

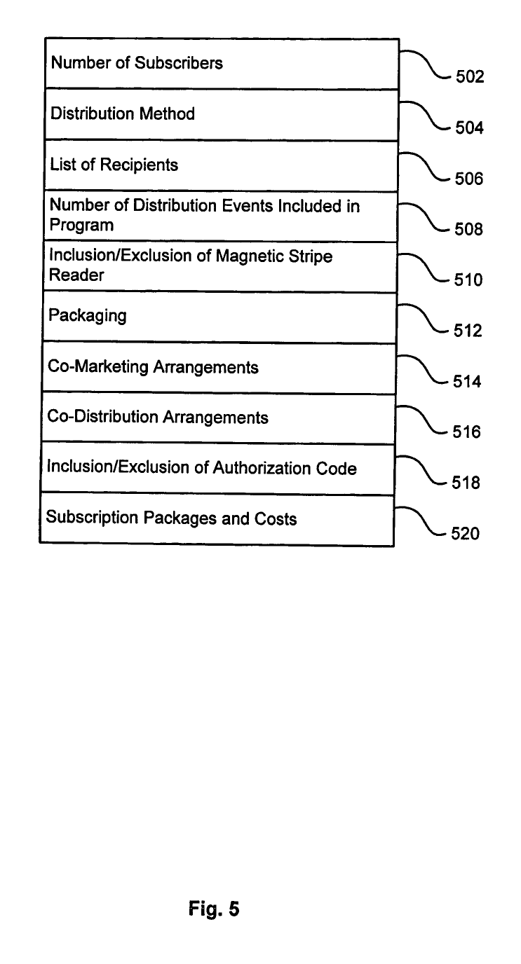

FIG. 5 is a block diagram illustration of the components of distribution programs according to the present invention. The components applicable to each distribution program will be defined as part of the project. The number of subscribers 502 may vary with each program and will be established as early as possible. One or more distribution methods 504 will be established for each program. In one embodiment, a distribution program may utilize direct mail as the distribution method. A list of recipients 506 may be identified for a distribution program. The distribution list will be used to facilitate distribution of magnetic cards and readers through methods such as direct mail. It will also enable the tracking of recipients who have received magnetic card readers in order to avoid/minimize repetitive distribution of readers to the same recipient. However, distribution lists will not always be required, nor desired. As readers become widely distributed, distribution of magnetic strip cards can be accomplished with or without recipient lists, since many recipients will have been enabled. Also, in some programs, tracking the distribution of card readers may not be required. Number and pattern of the distribution events 508 may indicate that the distribution program has a monthly distribution schedule, or the distribution program may have a one-time only distribution. For each program, the inclusion or exclusion 510 of a card reader will be established. Should a card reader be included in the program, the distribution list will be compared to previous distribution lists to determine which recipients have already received a card reader, in which case a reader will not be provided to those recipients. How the cards, and readers, where applicable, are packaged 512 will also be established for each program. The extent and content of co-marketing 514 and co-distribution arrangements 516 will also be established as part of each distribution program. The inclusion of an authorization 518 code as part of the distribution program will also be established. Subscription packages and associated costs 520 will be prepared to offer to potential subscribers.

(5) Methods of Producing Advertisements for Use in Connection with the Invention

Art work for the cards/distribution media is developed by the subscribers, or developed for the subscriber in conjunction with the program.

Subscribers provide the address (URL or IP address) to be encoded on the magnetic strip associated with their art work.

Magnetic strip cards are produced which include the art work and an encoded magnetic strip. The encoding will include the commands necessary to have the browser access the specified page (address).

In addition to the current art for the production of cards with magnetic strip, it is desirable to produce sheets of magnetic strip cards, which may be detached and used with a reader. In one embodiment contemplated, the sheet of multiple cards would the size of a magazine page, or standard 8½×11″ sheet of paper. The sheet will be formatted and art work coordinated so as to represent multiple cards, which could be in rows and columns as well as other configurations, and include perforations such that the cards can be removed and used with a reader. A magnetic slurry or tape would be applied to the back of the sheet to form the magnetic strip in locations coordinated with the artwork such that when removed, the card would be functional in a reader. Encoding of the magnetic strips on the sheet would be accomplished using a recording unit designed to accommodate the multiple cards and magnetic strip locations, such that encoding of the entire sheet can be accomplished in one pass through the recorder. At an appropriate point in the process, the sheet would be perforated to allow the cards to be separated and used with a reader. The finished sheet may be bound in a magazine, distributed as separate sheets or packaged as a set of sheets.

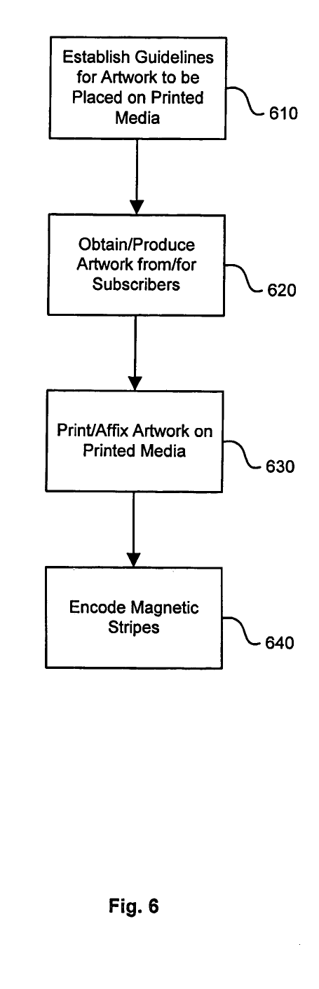

FIGS. 6 and 7 are flowcharts respectively depicting the operations of producing and distributing cards according to an embodiment of the present invention. FIGS. 6 and 7 show the operation of steps 120 and 130, respectively, in FIG. 1 in further detail, including the following steps:

Establish guidelines for artwork for advertisements to be placed in the printed media (610), which may include the design of the artwork as well as the information content to be included in the artwork.

Obtain from the subscriber, or produce for the subscriber, artwork conforming to said guidelines (620).

Print or affix said artwork on the printed media (630).

Encode magnetic stripes on the media (640), which may include the target URL or other addressing information, information or commands for a web browser to properly access the web page, or program instructions for the browser or a software driver. In another embodiment, the printed media in the present invention may be magnetic stripes attached to other types of media, such as magazines or newspapers, which can likewise be distributed to the recipients and the information contained in the magnetic stripe can likewise be scanned by a reader.

Collate printed media into a card pack (710). In an alternative embodiment, the printed media may not be collated and they may be distributed to the recipients individually.

Package collated cards for distribution (720).

Bundle printed media pack with reader if applicable (730). If a recipient of the printed media does not currently have a reader, then a reader is bundled and distributed. Otherwise if a recipient already has a reader, then another reader is not bundled and distributed.

Distribute pack via suitable means, such as direct mail or bundling with other products (740). The printed media, such as collated card bundles or individual cards, may be mailed to the recipients as a stand alone package or they may be packaged together with other products such as magazines. In an alternative embodiment, the printed media may be distributed as a handout, with no cost to the recipients. In another alternative embodiment, wholesale or retail channels may be employed to sell the printed media to the recipients.

In another embodiment, business cards with magnetic strips encoded with information on the business card would be produced to facilitate transfer of information (name, company, address, phone no., email address, other) on the business card to a PC based address book, database or other program. One distribution method would be to include a magnetic strip reader, multiple readers, with each order of new business cards with encoded magnetic strips. Distribution may also include programs in which a pack of business cards representing multiple individuals are distributed via methods discussed elsewhere in this document.

(6) Methods of Distributing Advertisements in Conjunction with Print Media

The sequence and selection of steps involved in practicing the invention may vary, depending on the distribution program in use. Examples of distribution programs include:

1. A distribution program consisting of multiple distribution events (e.g. monthly for one year) in which a number of subscribers (e.g. 100) contract to have cards with advertising and encoded magnetic strip produced and distributed in a common package.

2. A distribution program consisting of a single distribution event in which a number of subscribers (say 100) contract to have cards with advertising and encoded magnetic strip produced and distributed in a common package.

3. A distribution program consisting of single or multiple distribution events in which one subscriber contracts to have one or more cards with advertising and encoded magnetic strip produced and distributed.

4. The above programs in which a magnetic strip reader for the recipients is included in the program such that there is no cost to the recipient.

5. The above programs in which a magnetic strip reader for the recipients is provide for a fee.

6. The above programs in which there is a cost to the recipient for the card pack and the reader, separately or in combination.

7. The programs stated above with the magnetic strip attached to other types and size media.

8. The programs may include software to capture and store information from swiped cards for future use.

9. A software program may be provided which is activated by the browser program or applet once the card is swiped which captures the information from the magnetic strip, saves it in a database, and then directs the browser program to access the associated page address.

10. The software program in #9 may be a standalone program which first captures the magnetic strip information and then direct the browser program to access the associated web page.

11. The magnetic strip card can include instructions to be executed by various software programs, rather than accessing an Internet page.

The present invention represents a novel and convenient method of accessing electronic media using information published in connection with print media. A substantial increase in efficiency is provided. A further advantage of combining electronic and printed media is that electronic media may be updated frequently, so that advertisers may have the opportunity to provide the latest information to the recipients, without having to update the corresponding printed media.

Another advantage is that the space in which to display information in electronic media can be much greater and/or inexpensive than is generally possible in printed media.

It is evident that the embodiments described herein accomplish the stated objects of the invention. While the presently preferred embodiments have been described in detail, it will be apparent to those skilled in the art that the principles of the invention are realizable by other devices, systems and methods without departing from the scope and spirit of the invention, as will be defined in the claims.

I claim:

1. A device for reading information recorded on a magnetic strip incorporated in printed media, comprising:
a first guide member;
a second guide member disposed in proximity to said first guide member to form a groove through which said magnetic strip may be slidably moved;
a magnetic reading head having a contact end disposed in said groove and facing said first guide member which is operable when said magnetic strip is slidably moved through said groove to generate an electrical signal therefrom;
a strip of resilient material held in a flexed position between a pair of mounts disposed on either side of said magnetic reading head, so as to cause said strip to engage said magnetic reading head and apply a force thereto so as to bias said contact end thereof toward said first guide member; and
a circuit to process said electronic signal to generate therefrom an output compatible with a peripheral input provided on a computer.
